(19) United States
(12) Patent Application Publication
(10) Pub. No.: US 2013/0177896 A1
(43) Pub. Date: Jul. 11, 2013

(54) TEACHING TOOL FOR UNDERSTANDING SHAPES WHICH HAVE VARYING FORMS DEPENDING ON VIEWING POSITION

(71) Applicants: Dong Chul Kim, Gyeonggi-do (KR); Mi Ryung Barn, Gyeonggi-do (KR)

(72) Inventors: Dong Chul Kim, Gyeonggi-do (KR); Mi Ryung Barn, Gyeonggi-do (KR)

(21) Appl. No.: 13/818,539

(22) PCT Filed: Jul. 13, 2011
(86) PCT No.: PCT/KR11/05126

§ 371 Date: Feb. 22, 2013

(30) Foreign Application Priority Data
Sep. 28, 2010 (KR) 10-2010-0093791

(51) Int. Cl. G09B 1/00

(52) U.S. Cl. CPC G09B 1/00
USPC 434/430

(57) ABSTRACT

The present invention discloses a teaching tool for easier understanding of a diagram looking different depending on viewing angles. The teaching tool includes a transparent body (3) composed of transparent plates (1), and a plurality of circular rings (2) arranged within the transparent body (3) at a specified interval.

### FIELD OF THE INVENTION

The present invention relates to a teaching tool for enabling a learner to easily understand a diagram looking different depending on viewing angles.

### BACKGROUND OF THE INVENTION

The shape of a diagram is differently seen depending on viewing angles. For instance, a perfect circle looks perfectly circular when viewed from the front side thereof. However, if the viewing angle is changed even a little bit, the perfect circle looks elliptical. When a plurality of perfect circles is observed from a position than a front position, the perfect circles looks as if they have many different elliptical shapes, depending on the distances to the respective perfect circles.

There has existed a strong demand for a teaching tool that enables a learner to easily understand a diagram looking different depending on viewing angles and viewing distances. However, such a teaching tool has not been developed thus far.

In respect of a hexahedron, there is a strong demand for a teaching tool that enables a learner to easily understand how a hidden facet looks like depending on viewing angles. However, there is still unavailable a teaching tool that can comply with this demand.

### SUMMARY OF THE INVENTION

### Problems to be Solved

In view of these circumstances, it is an object of the present invention to provide a teaching tool capable of enabling a learner to easily understand a diagram looking different depending on viewing angles and viewing distances.

### Means for Solving the Problems

In order to achieve this object, the present invention provides a teaching tool for easier understanding of a diagram looking different depending on viewing angles, including: a transparent body composed of transparent plates; and a plurality of circular rings arranged within the transparent body at a specified interval.

The present invention provides a teaching tool for easier understanding of a diagram looking different depending on viewing angles, including: a hollow transparent cylindrical columnar body having an outer circumferential surface; and a plurality of circular bands arranged on the outer circumferential surface of the hollow transparent cylindrical columnar body at a specified interval.

The present invention provides a teaching tool for easier understanding of a diagram looking different depending on viewing angles, including: a plurality of transparent cylindrical columnar members; and a plurality of circular rings interposed between the transparent cylindrical columnar members, wherein the transparent cylindrical columnar members and the circular rings are alternately arranged and are bonded to one another.

The present invention provides a teaching tool for easier understanding of a diagram looking different depending on viewing angles, including: a transparent hexahedral body composed of transparent plates; and a plurality of circular rings arranged on the transparent plates in a mutually opposing relationship at a specified interval along a longitudinal direction of the transparent hexahedral body.

The present invention provides a teaching tool for easier understanding of a diagram looking different depending on viewing angles, including: a transparent hexahedral body composed of transparent plates; and a plurality of horizontal bands arranged on the transparent hexahedral body at a specified interval, wherein the hexahedral body is divided into a plurality of hexahedral body parts by the horizontal bands.

The present invention provides a teaching tool for easier understanding of a diagram looking different depending on viewing angles, including: a plurality of transparent hexahedral bodies; and a plurality of opaque hexahedral bodies smaller in width than the transparent hexahedral bodies, wherein the transparent hexahedral bodies and the opaque hexahedral bodies are alternately arranged and are bonded to one another.

The present invention provides a teaching tool for easier understanding of a diagram looking different depending on viewing angles, including: an outer transparent cylindrical columnar body; a plurality of outer circular rings arranged on an inner circumferential surface of the outer transparent cylindrical columnar body; an inner transparent cylindrical columnar body arranged at a center of the outer transparent cylindrical columnar body; and a plurality of inner circular rings arranged on the inner transparent cylindrical columnar body in alignment with the outer circular rings.

### Effect of the Invention

According to the present invention, it is possible to provide a teaching tool that enables a learner to easily understand a diagram looking different depending on viewing angles and viewing distances.

### BRIEF DESCRIPTION OF THE DRAWINGS

FIG. 1 is an exploded perspective view showing a teaching tool according to a first embodiment of the present invention.

FIG. 2 is an assembled front view of the teaching tool shown in FIG. 1.

FIG. 3 is another assembled front view of the teaching tool shown in FIG. 1.

FIG. 4 is a perspective view showing a teaching tool according to a modified example.

FIG. 5 is perspective view of the teaching tool shown in FIG. 4, which is viewed in another position.

FIGS. 6 and 7 are views showing a teaching tool according to another modified example.

FIG. 8 is an exploded perspective view showing a teaching tool according to a further modified example.

FIG. 9 is an assembled perspective view of the teaching tool shown in FIG. 8.

FIG. 10 is a section view showing a modified example of the teaching tool shown in FIG. 9.

FIGS. 11 and 12 are views for explaining the teaching tool shown in FIG. 8.

FIG. 13 is an exploded perspective view showing a teaching tool according to a second embodiment of the present invention.

FIG. 14 is an assembled front view of the teaching tool shown in FIG. 13.

FIG. 15 is an end view of the teaching tool shown in FIG. 13.

FIGS. 16 through 19 are views for explaining different use states of the teaching tool according to the second embodiment of the present invention.

FIGS. 20 and 21 are views showing a teaching tool according to a modified example.

FIGS. 22 and 23 are views showing a teaching tool according to another modified example.

### DETAILED DESCRIPTION OF THE PREFERRED EMBODIMENTS

Certain preferred embodiments of a teaching tool according to the present invention will now be described in detail with reference to the accompanying drawings.

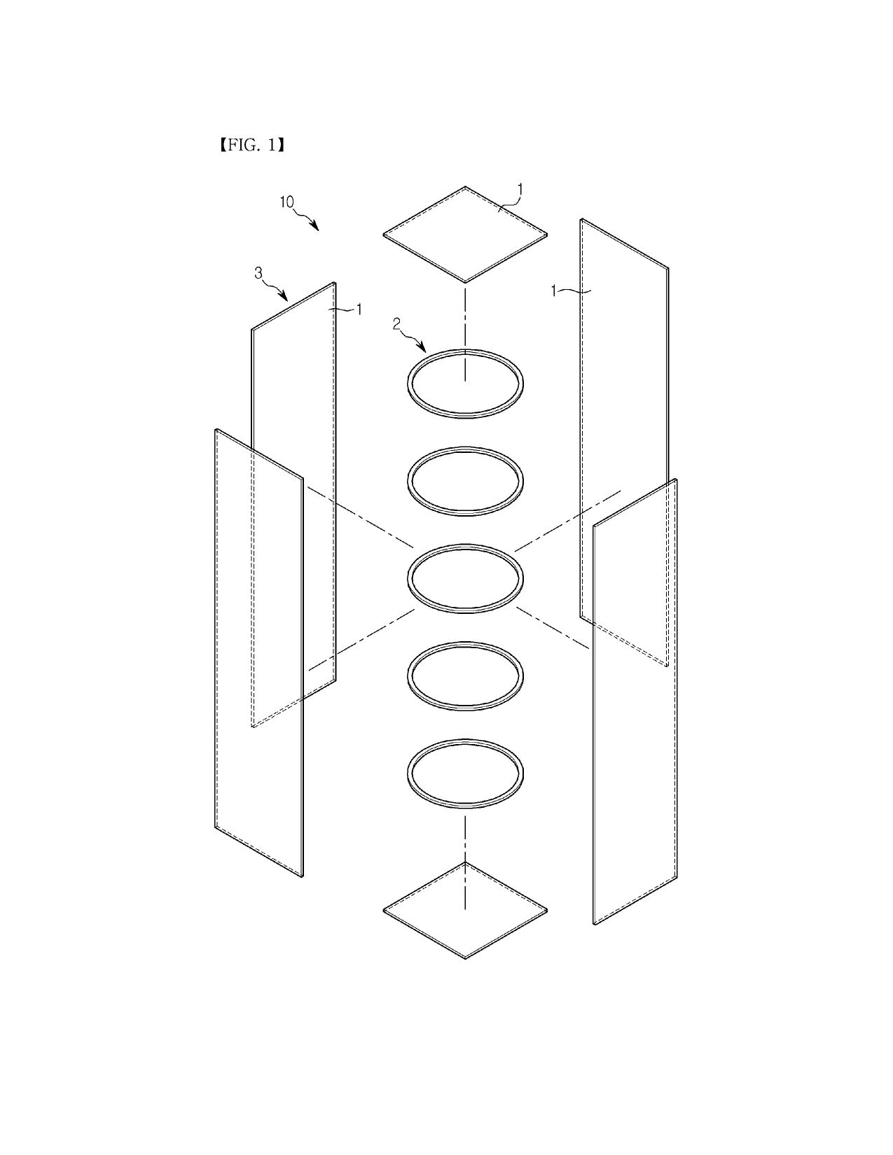

FIG. 1 is a view for illustrating how a plurality of perfect circles looks different depending on viewing angles.

A teaching tool 10 according to a first embodiment of the present invention includes a plurality of transparent panels 1 forming a hexahedral body 3 when assembled and a plurality of circular rings 2 arranged within the hexahedral body 3 in a spaced-apart relationship. The circular rings 2 may has a specified color so that they can be readily identified from the outside.

For the sake of easier understating of the present invention, description will be made on an example in which the circular rings 2 are arranged at a regular interval.

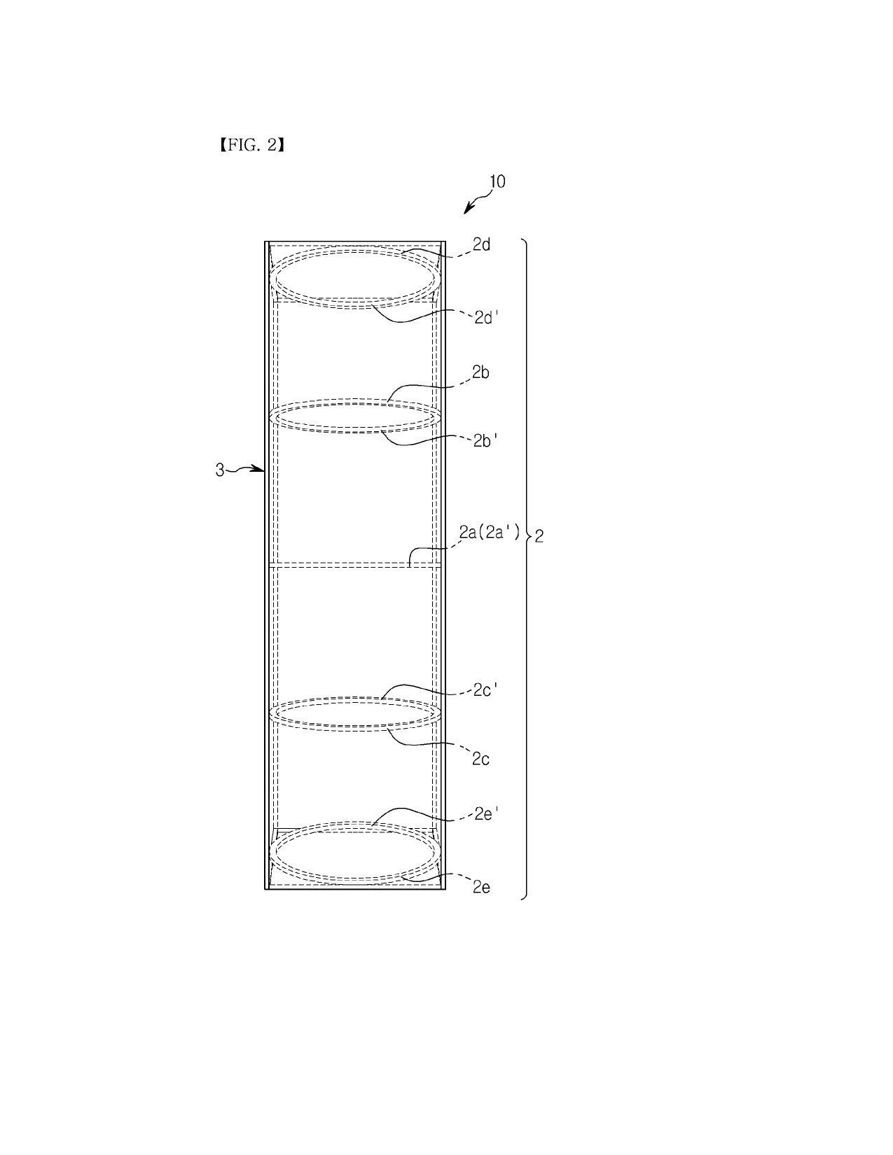

The circular rings 2 can be observed from the outside through the transparent panels 1. If the teaching tool 10 is observed with the line of sight matched to a central circular ring 2a, the central circular ring 2a looks like a line 2a′ as shown in FIG. 2.

However, the intermediate circular rings 2b and 2c spaced apart to the upper and lower sides from the central circular ring 2a look like elliptical rings 2b′ and 2c′ having a narrow width. This is because the line of sight is moved up and down from the central circular ring 2a.

At this time, if the distance from the central circular ring 2a to the intermediate circular ring 2b differs from the distance from the central circular ring 2a to the intermediate circular ring 2c, the intermediate circular rings 2b and 2c look like elliptical rings having different shapes.

The top circular ring 2d positioned above the intermediate circular ring 2b is spaced apart from the central circular ring 2a farther than the intermediate circular ring 2b and, therefore, can be observed with a wide visual field. Thus, the top circular ring 2d looks like an elliptical ring 2d′ having a width larger than the width of the intermediate circular ring 2b. Similarly, the bottom circular ring 2e positioned below the intermediate circular ring 2c is spaced apart from the central circular ring 2a farther than the intermediate circular ring 2C and, therefore, can be observed with a wide visual field. Thus, the bottom circular ring 2e looks like an elliptical ring 2e′ having a width larger than the width of the intermediate circular ring 2c.

At this time, if the distance from the central circular ring 2a to the top circular ring 2d differs from the distance from the central circular ring 2a to the bottom circular ring 2e, the top and bottom circular rings 2d and 2e look like elliptical rings having different shapes.

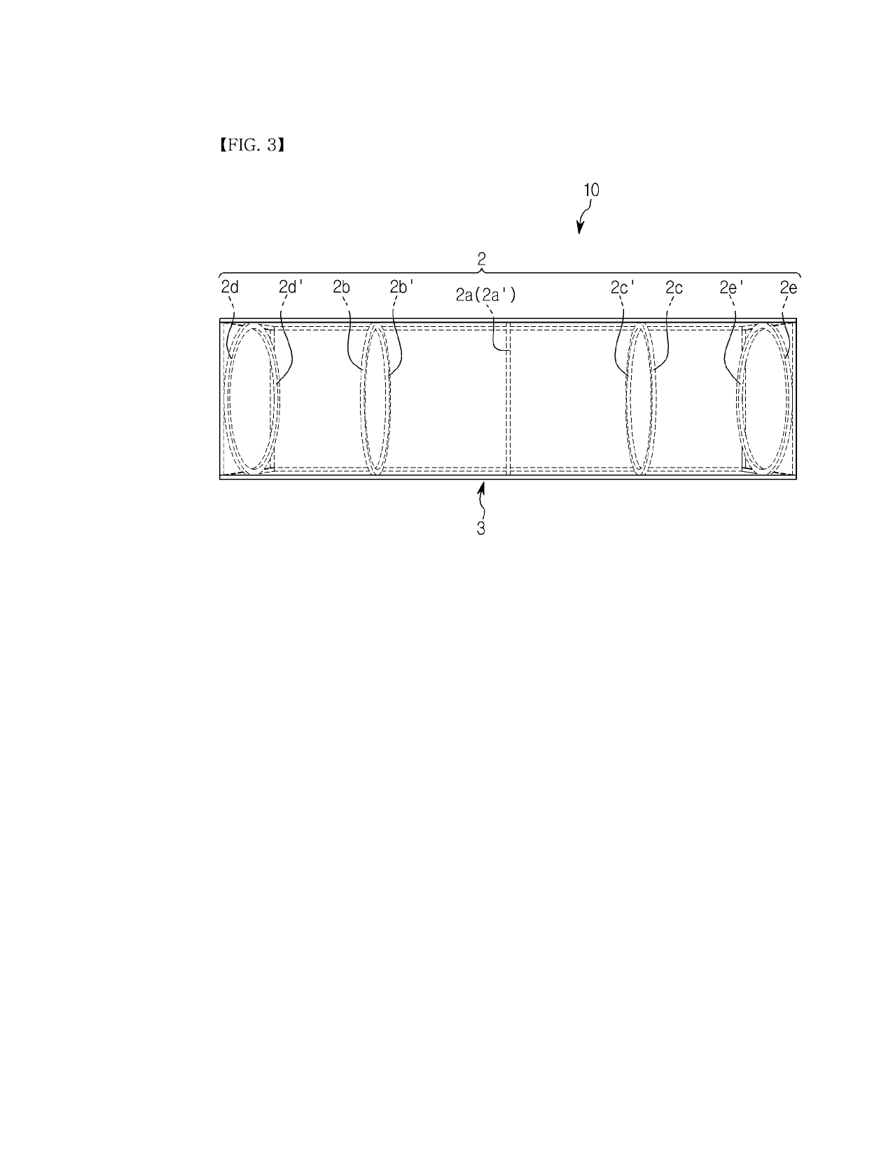

While the circular rings 2 are horizontally positioned in the example shown in FIG. 2, the circular rings 2 can be vertically positioned by laying down the teaching tool 10 as shown in FIG. 3. Even in this case, the central circular ring 2a looks like a line 2a′ if the line of sight is matched to the central circular ring 2a.

However, the intermediate circular rings 2b and 2c spaced apart to the left and right sides from the central circular ring 2a look like elliptical rings 2b′ and 2c′ having a narrow width. This is because the line of sight is moved the left and right sides from the central circular ring 2a.

At this time, if the distance from the central circular ring 2a to the intermediate circular ring 2b differs from the distance from the central circular ring 2a to the intermediate circular ring 2c, the intermediate circular rings 2b and 2c look like elliptical rings having different shapes.

The leftmost circular ring 2d positioned at the left side of the intermediate circular ring 2b is spaced apart from the central circular ring 2a farther than the intermediate circular ring 2b and, therefore, can be observed with a wide visual field. Thus, the leftmost circular ring 2d looks like an elliptical ring 2d′ having a width larger than the width of the intermediate circular ring 2b. Similarly, the rightmost circular ring 2e positioned at the right side of the intermediate circular ring 2c is spaced apart from the central circular ring 2a farther than the intermediate circular ring 2C and, therefore, can be observed with a wide visual field. Thus, the rightmost circular ring 2e looks like an elliptical ring 2e′ having a width larger than the width of the intermediate circular ring 2c.

As stated above, if the line of sight is matched to the central circular ring 2a, it is possible to visually recognize how the visual shapes of the circular rings 2b, 2c, 2d and 2e are changed from the visual shape of the central circular ring 2a depending on the viewing angles. Likewise, if the line of sight is matched to, e.g., the intermediate circular ring 2b, it is possible to visually recognize how the visual shapes of the circular rings 2a, 2c, 2d and 2e are changed from the visual shape of the intermediate circular ring 2b depending on the viewing angles.

With the teaching tool 10 of the present invention, a learner can visually recognize with ease how the visual shapes of the circular rings are changed depending on the viewing angles and the viewing distances.

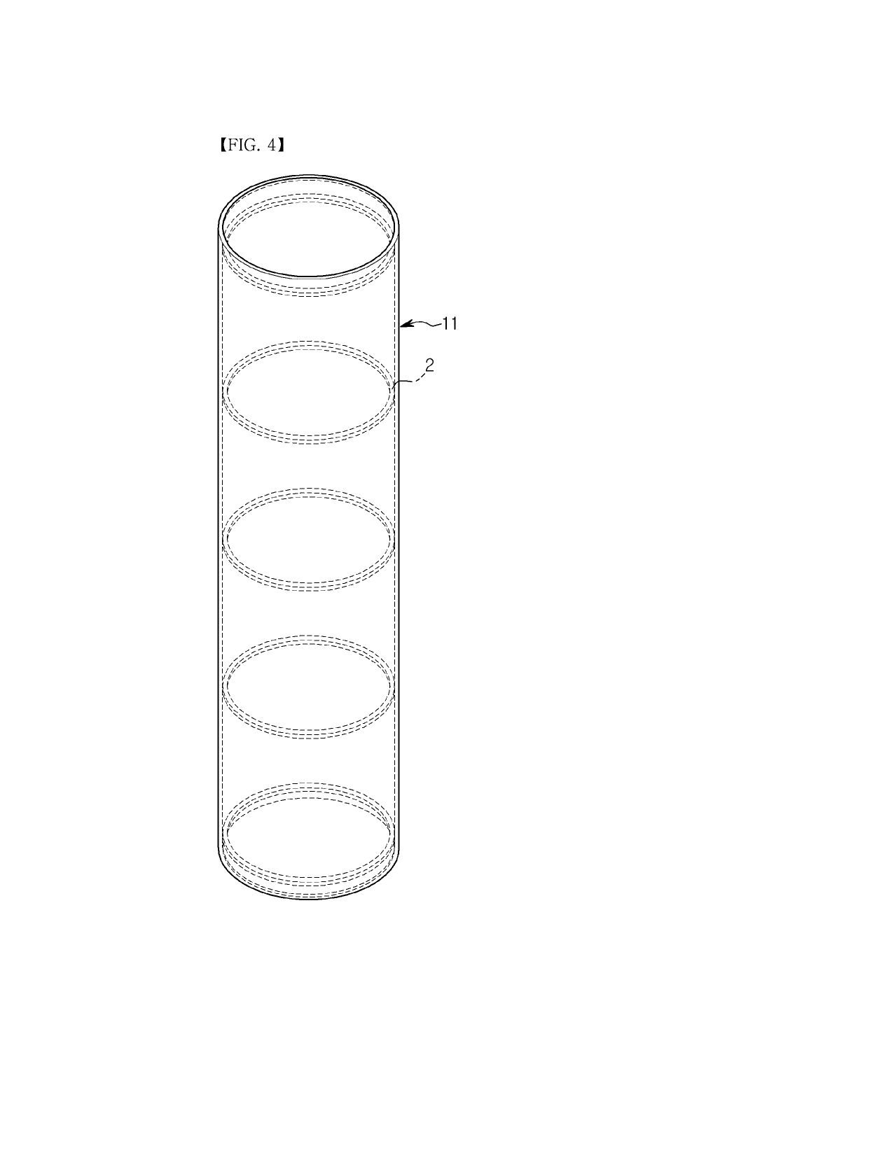

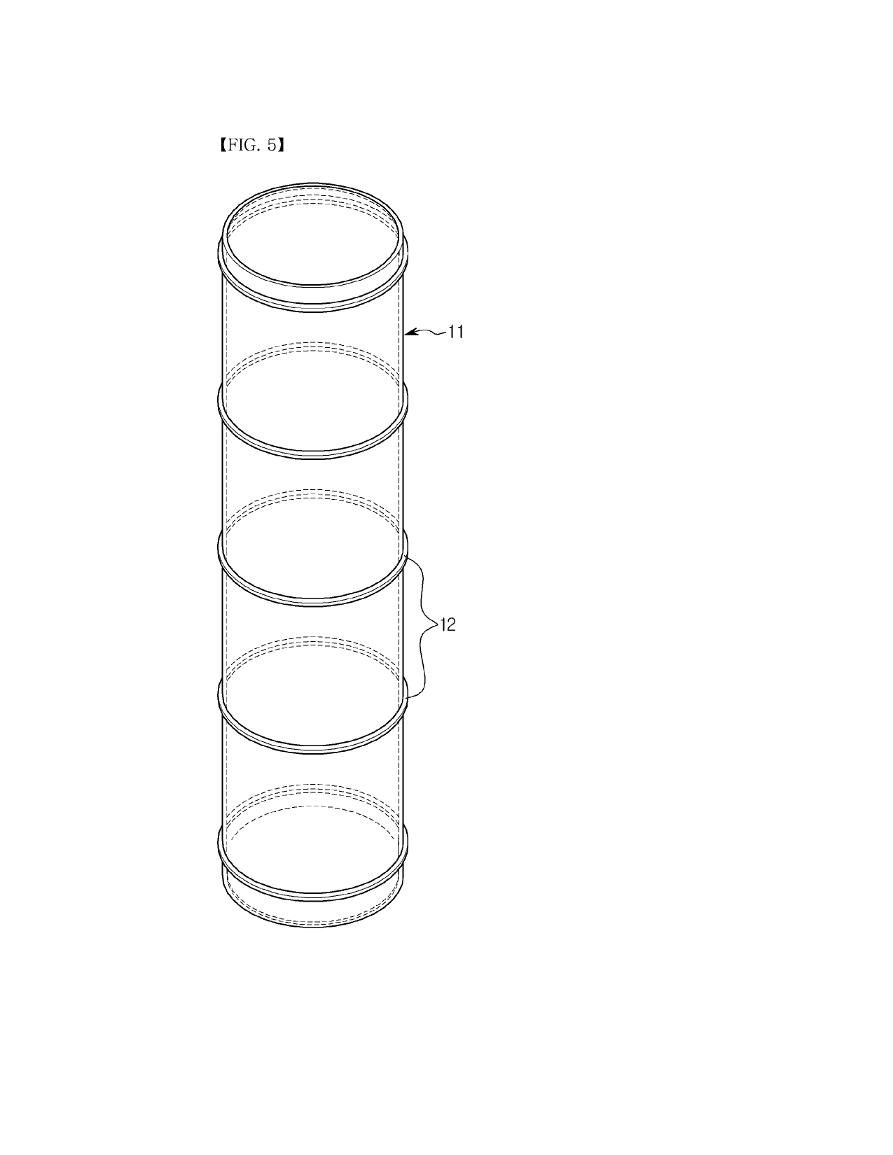

The hexahedral body 3 of the teaching tool 10 described above may have a regular hexahedron shape or a rectangular parallelepiped shape. Alternatively, as shown in FIG. 4, the teaching tool may be configured to include a transparent hollow cylindrical columnar body 11 and a plurality of circular rings 2 arranged within the cylindrical columnar body 11. As illustrated in FIG. 5, the teaching tool may further include a plurality of circular bands 12 attached to the outer circumferential surface of the cylindrical columnar body 11. In this case, the circular rings 2 and the circular bands 12 may be arranged at a regular interval or at different intervals.

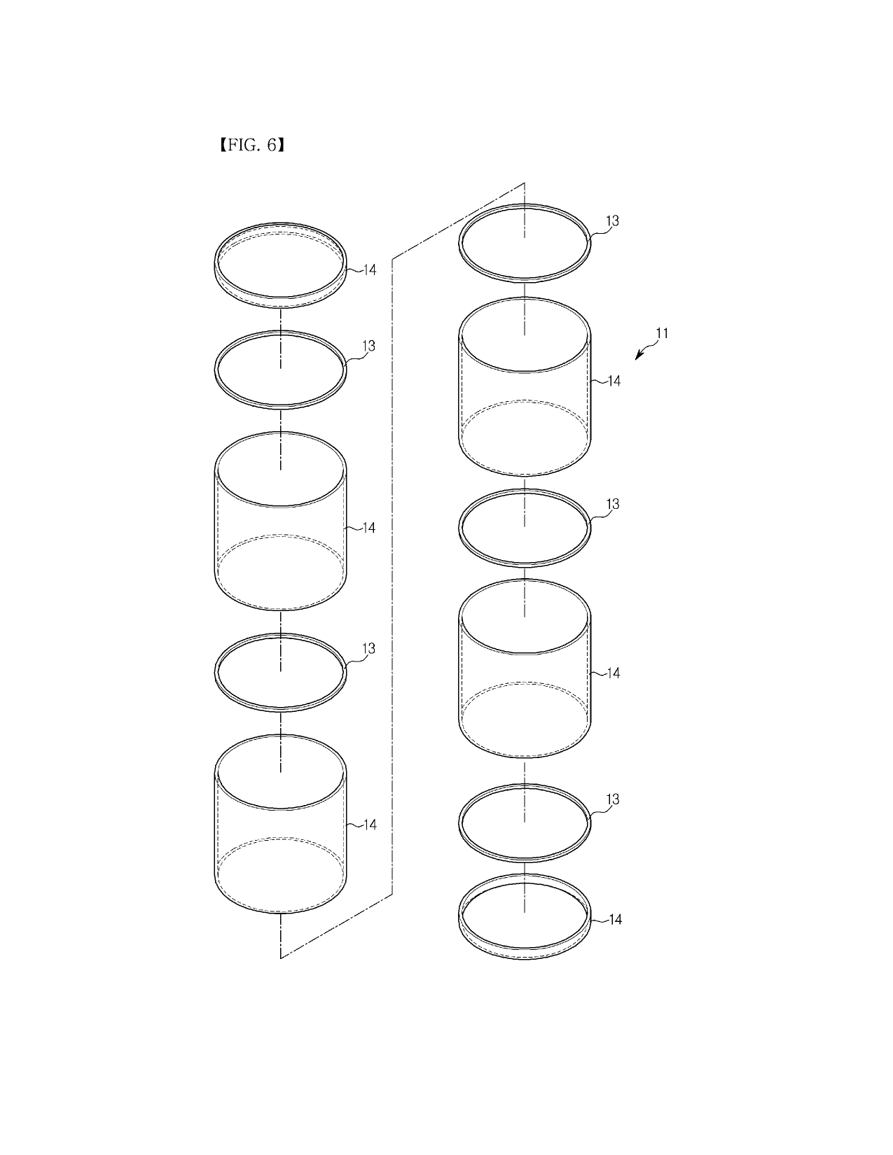

As shown in FIG. 6, the teaching tool may be configured to include a plurality of transparent cylindrical columnar members 14 and a plurality of circular rings 13 interposed between the respective cylindrical columnar members 14. The cylindrical columnar members 14 and the circular rings 13 are alternately arranged and are bonded to one another.

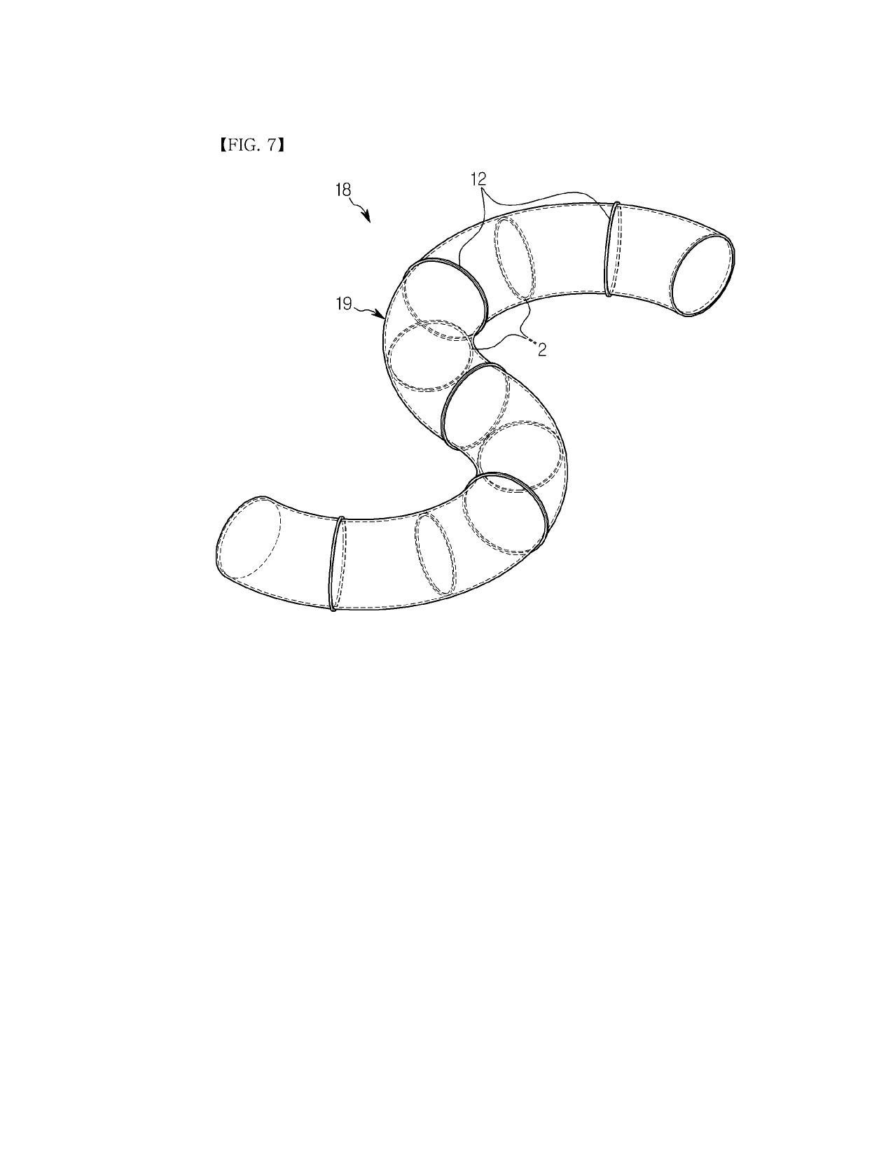

As depicted in FIG. 7, the teaching tool may be configured to include a transparent cylindrical columnar body 18 having a curved shape and a plurality of circular rings 2 arranged within the cylindrical columnar body 18. The teaching tool may further include a plurality of circular bands 12 attached to the outer circumferential surface of the cylindrical columnar body 18. In this case, it is possible to visually recognize how the visual shapes of the circular rings 2 and the circular bands 12 are changed in the curved portions 19.

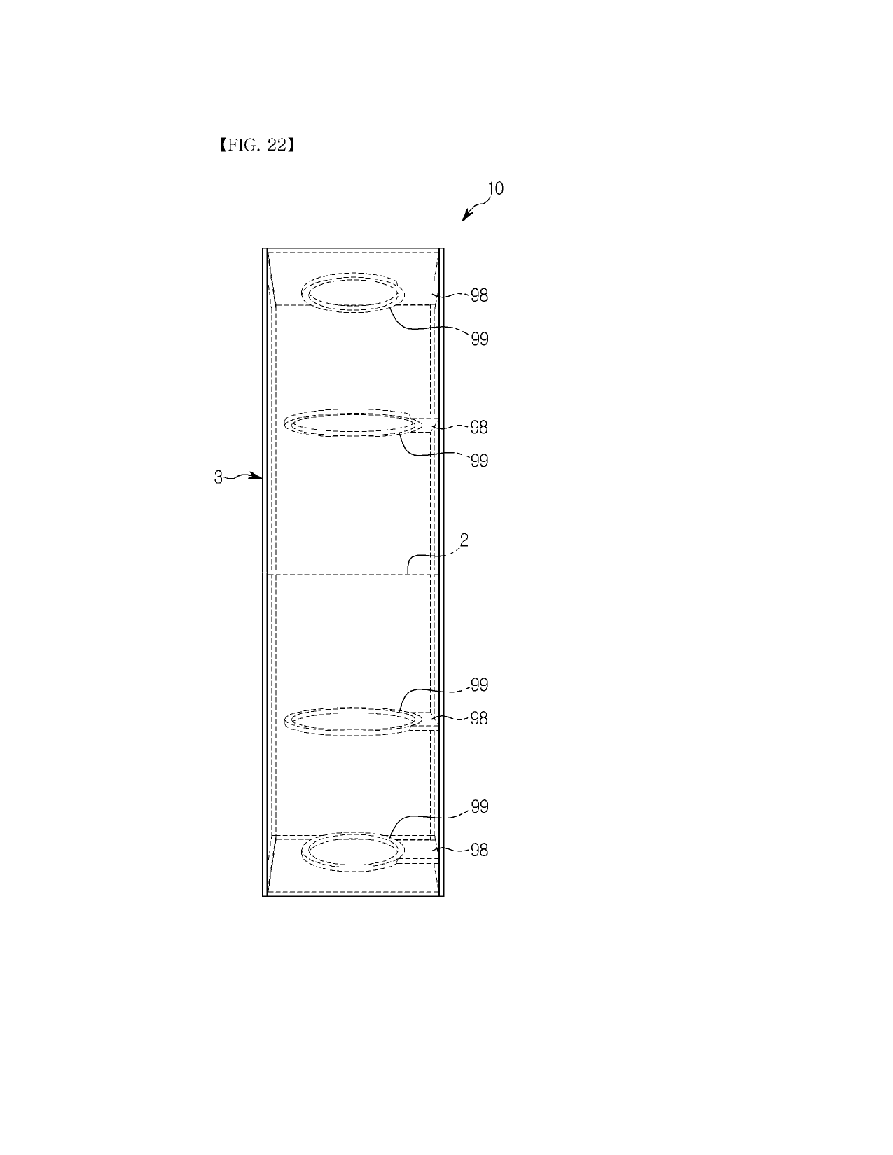

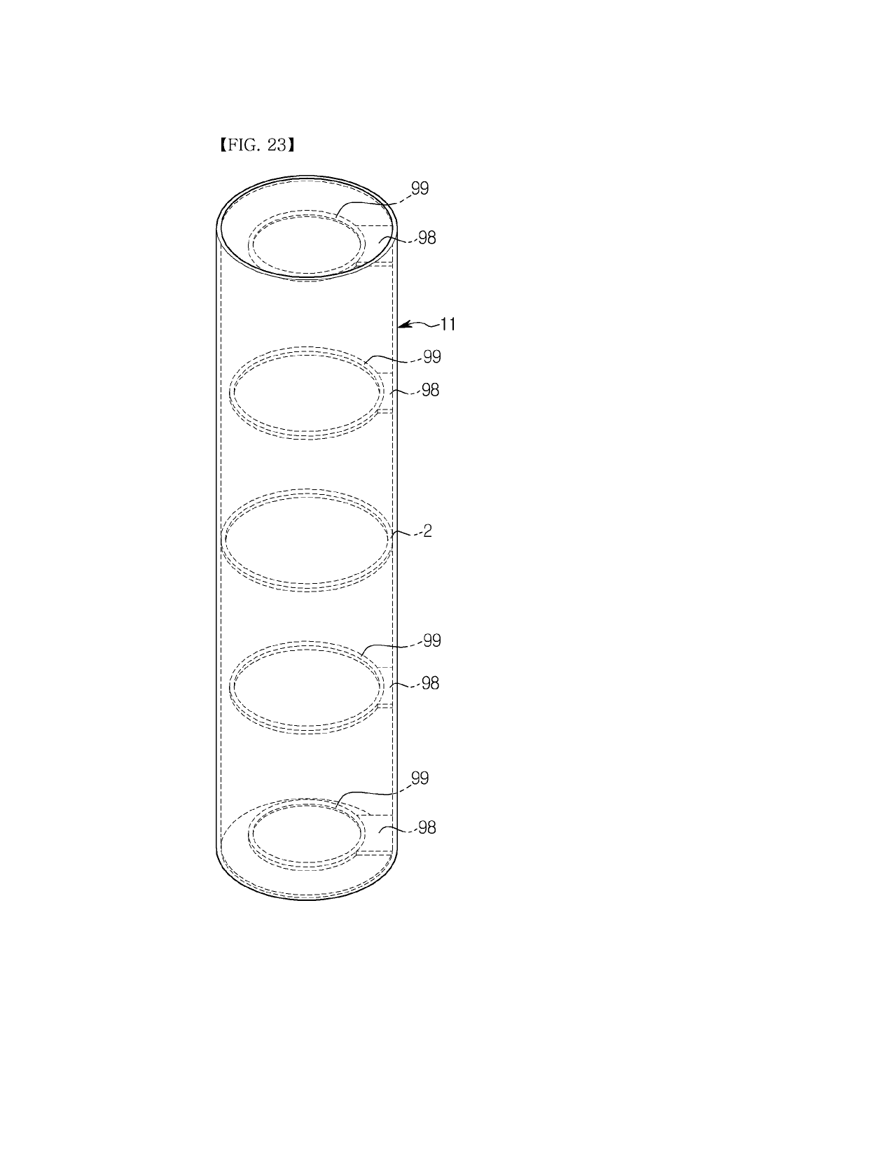

In the hexahedral body 3, the cylindrical columnar body 11 and the curved cylindrical columnar body 18 described above, the circular rings 2 arranged therein are equal in size to one another. Alternatively, as shown in FIGS. 22 and 23, large circular rings 2 and small circular rings 99 may be arranged within the hexahedral body 3, the cylindrical columnar body 11 or the curved cylindrical columnar body 18. In this case, transparent support brackets 98 may be used to install the small circular rings 99 in place.

If the large circular rings 2 and the small circular rings 99 are employed in combination as mentioned above, it is possible to enhance the learner's ability to determine a spatial geometry.

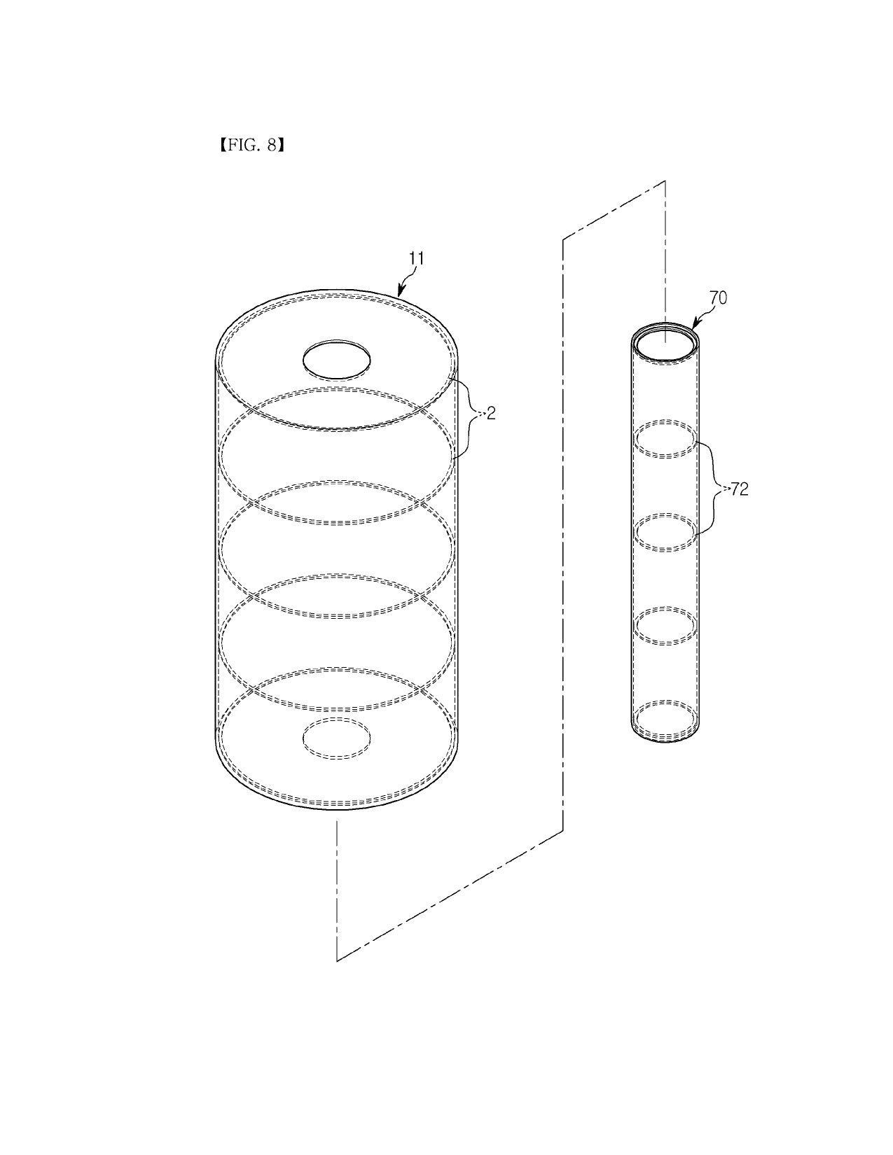

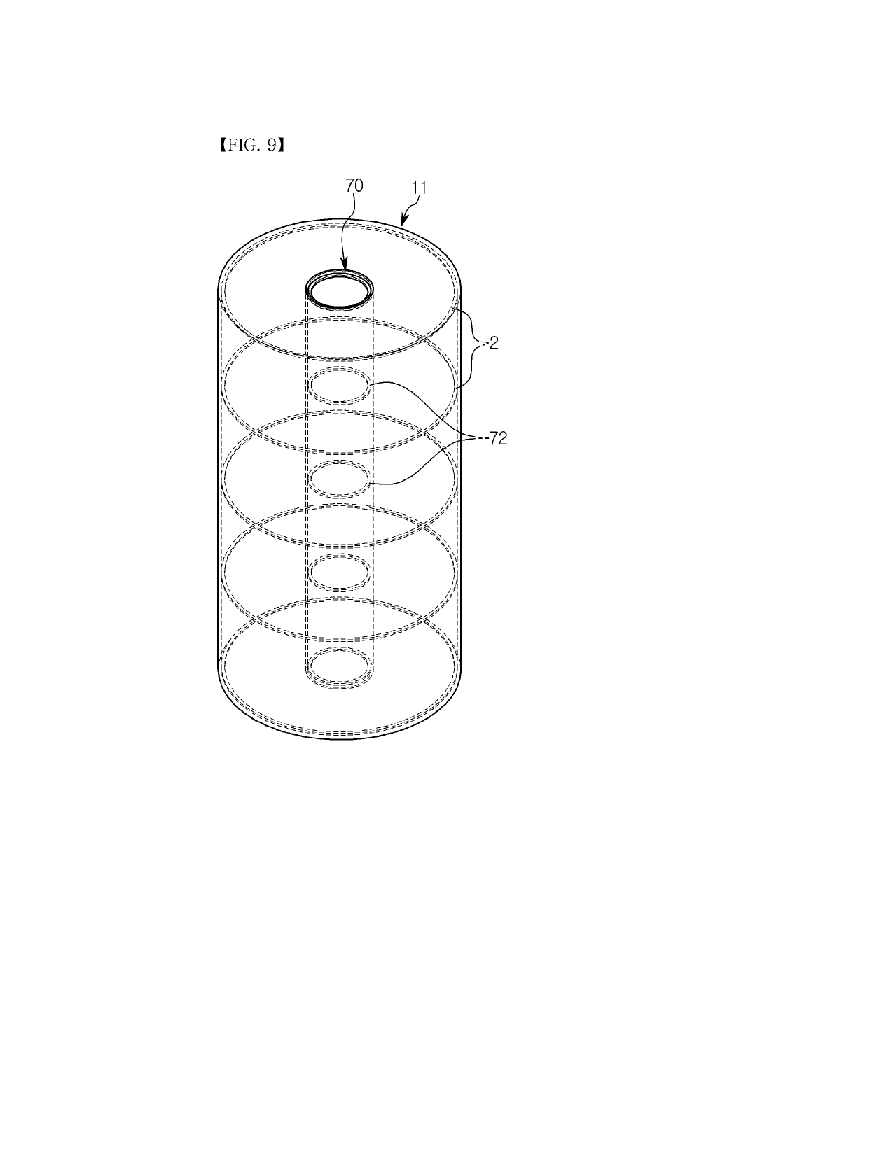

The present invention may be modified as illustrated in FIGS. 8 through 10.

The teaching tool shown in FIGS. 8 through 10 has a dual column structure in which circular rings having different sizes are arranged in different radial positions. This enables a learner to learn the concept of spatial geometry.

More specifically, the teaching tool shown in FIGS. 8 through 10 includes an outer transparent cylindrical columnar body 11, a plurality of outer circular rings 2 arranged on the inner circumferential surface of the outer transparent cylindrical columnar body 11, an inner transparent cylindrical columnar body 70 arranged at the center of the outer transparent cylindrical columnar body 11, and a plurality of inner circular rings 72 arranged on the inner circumferential surface of the inner transparent cylindrical columnar body 70 in alignment with the outer circular rings 2.

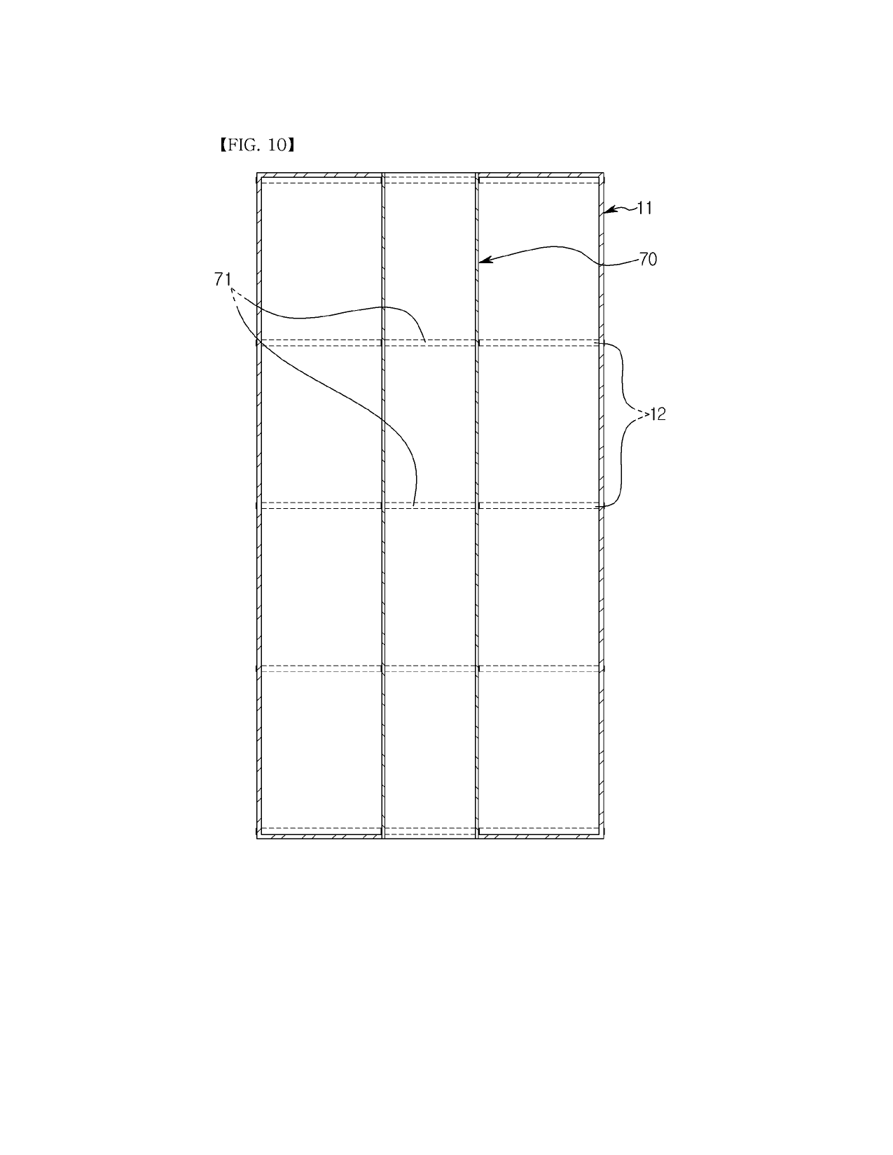

Instead of the inner circular rings 72 arranged on the inner circumferential surface of the inner transparent cylindrical columnar body 70, inner circular bands 71 may be arranged on the outer circumferential surface of the inner transparent cylindrical columnar body 70 as shown in FIG. 10. The inner circular rings 72 and the inner circular bands 71 may have a specified color so that they can be readily recognized through the outer transparent cylindrical columnar body 11 and the inner transparent cylindrical columnar body 70.

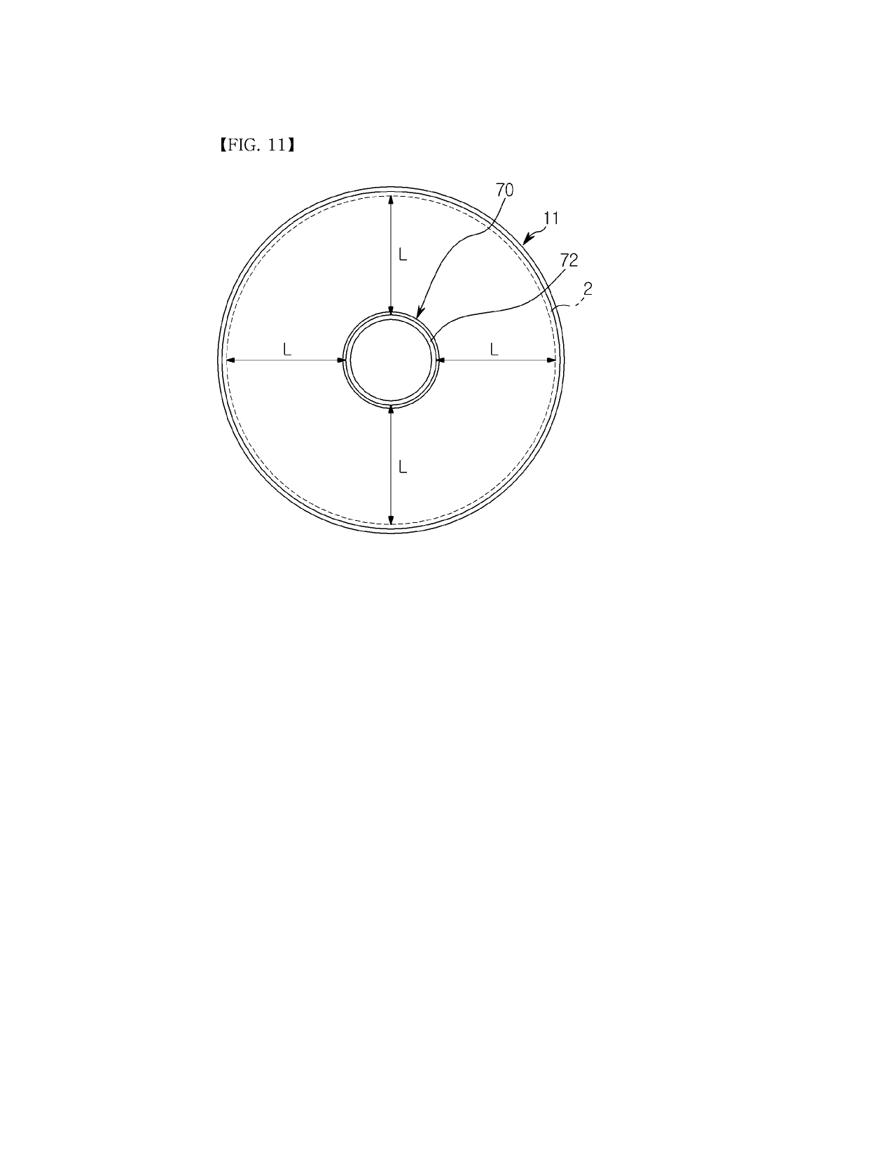

With this configuration, as shown in FIG. 11, the radial distances L between the outer transparent cylindrical columnar body 11 and the inner transparent cylindrical columnar body 70 are equal to one another. That is to say, the gap between the outer transparent cylindrical columnar body 11 and the inner transparent cylindrical columnar body 70 remains constant in all directions.

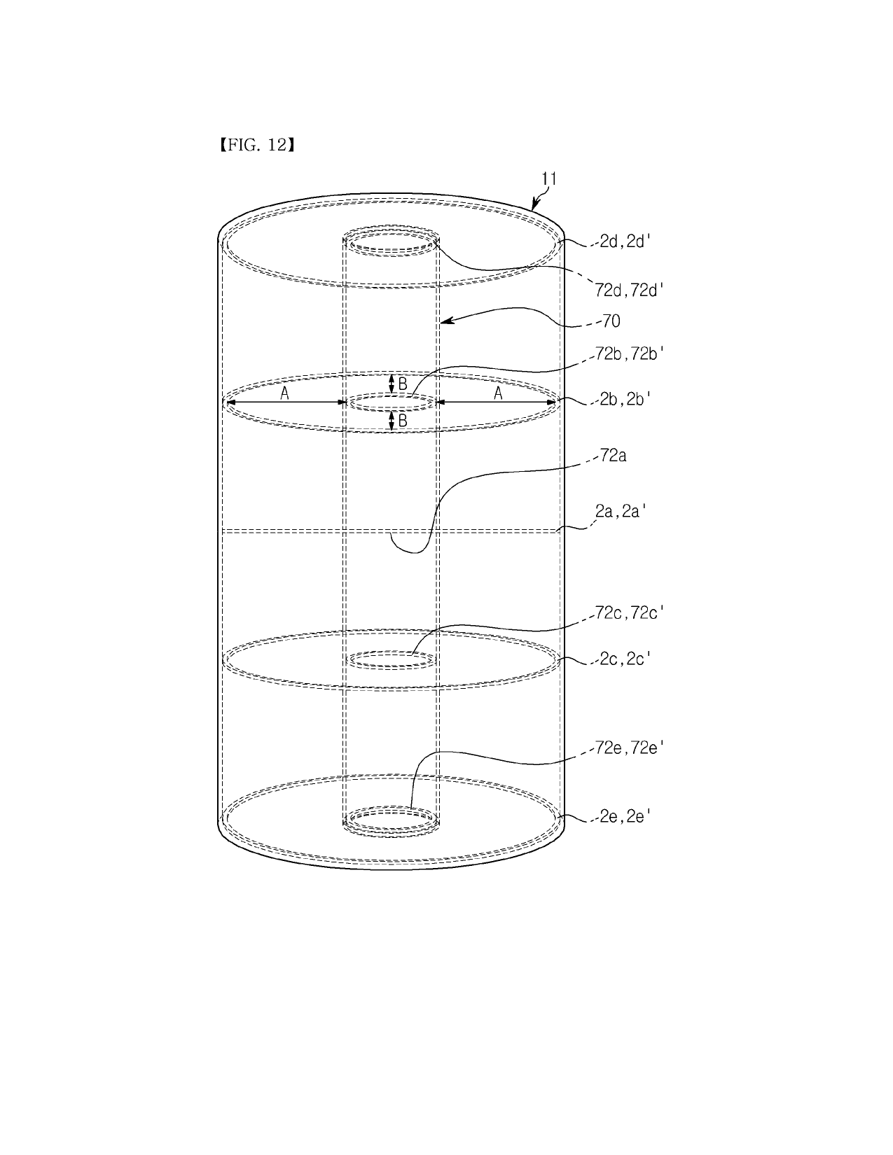

Referring to FIG. 12, if the line of sight is matched to the central outer circular ring 2a, the central outer circular ring 2a looks like a line 2a′. The central outer circular ring 72a is hidden by the central outer circular ring 2a and is not visible.

However, the intermediate outer circular rings 2b and 2c spaced apart to the upper and lower sides from the central outer circular ring 2a look like elliptical rings 2b′ and 2c′ having a narrow width. This is because the line of sight is moved up and down from the central outer circular ring 2a. At this time, the intermediate inner circular rings 72b and 72c positioned on the same plane as the intermediate outer circular rings 2b and 2c look like elliptical rings 72b′ and 72c.

The top outer circular ring 2d positioned above the intermediate outer circular ring 2b is spaced apart from the central outer circular ring 2a farther than the intermediate outer circular ring 2b and, therefore, can be observed with a wide visual field. Thus, the top outer circular ring 2d looks like an elliptical ring 2d′ having a width larger than the width of the intermediate outer circular ring 2b. Similarly, the bottom outer circular ring 2e positioned below the intermediate outer circular ring 2c is spaced apart from the central outer circular ring 2a farther than the intermediate outer circular ring 2C and, therefore, can be observed with a wide visual field. Thus, the bottom outer circular ring 2e looks like an elliptical ring 2e′ having a width larger than the width of the intermediate outer circular ring 2c.

The top inner circular ring 72d positioned above the intermediate inner circular ring 72b is spaced apart from the central inner circular ring 72a farther than the intermediate inner circular ring 72b and, therefore, can be observed with a wide visual field. Thus, the top inner circular ring 72d looks like an elliptical ring 72d′ having a width larger than the width of the intermediate inner circular ring 72b. Similarly, the bottom inner circular ring 72e positioned below the intermediate inner circular ring 72c is spaced apart from the central inner circular ring 72a farther than the intermediate inner circular ring 72c and, therefore, can be observed with a wide visual field. Thus, the bottom inner circular ring 72e looks like an elliptical ring 72e′ having a width larger than the width of the intermediate inner circular ring 72c.

As stated above, if the line of sight is matched to the central outer circular ring 2a, it is possible to visually recognize how the visual shapes of the outer circular rings 2b, 2c, 2d and 2e are changed from the visual shape of the central outer circular ring 2a depending on the viewing angles. Likewise, if the line of sight is matched to, e.g., the intermediate outer circular ring 2b, it is possible to visually recognize how the visual shapes of the outer circular rings 2a, 2c, 2d and 2e are changed from the visual shape of the intermediate outer circular ring 2b depending on the viewing angles.

With the teaching tool of the present invention, a learner can visually recognize with ease how the visual shapes of the circular rings are changed depending on the viewing angles and the viewing distances.

If the viewing positions are moved up or down, all the outer transparent cylindrical columnar body 11, the inner transparent cylindrical columnar body 70, the outer circular rings 2 and the inner circular rings 72 look elliptical. Thus, the left and right distances A look different than the up and down distances B. It goes without saying that, in reality, the left and right distances A are equal to the up and down distances B.

With the present invention, it is therefore possible to easily teach a learner the phenomenon that the distances look different even though they are actually equal to each other.

According to a second embodiment of the present invention, there is provided a teaching tool 22 that can enable a learner to visually recognize how a plurality of perfect circles looks different depending on the viewing angles and how the visual shape of a circular column interconnecting two perfect circles is changed depending on the viewing angles.

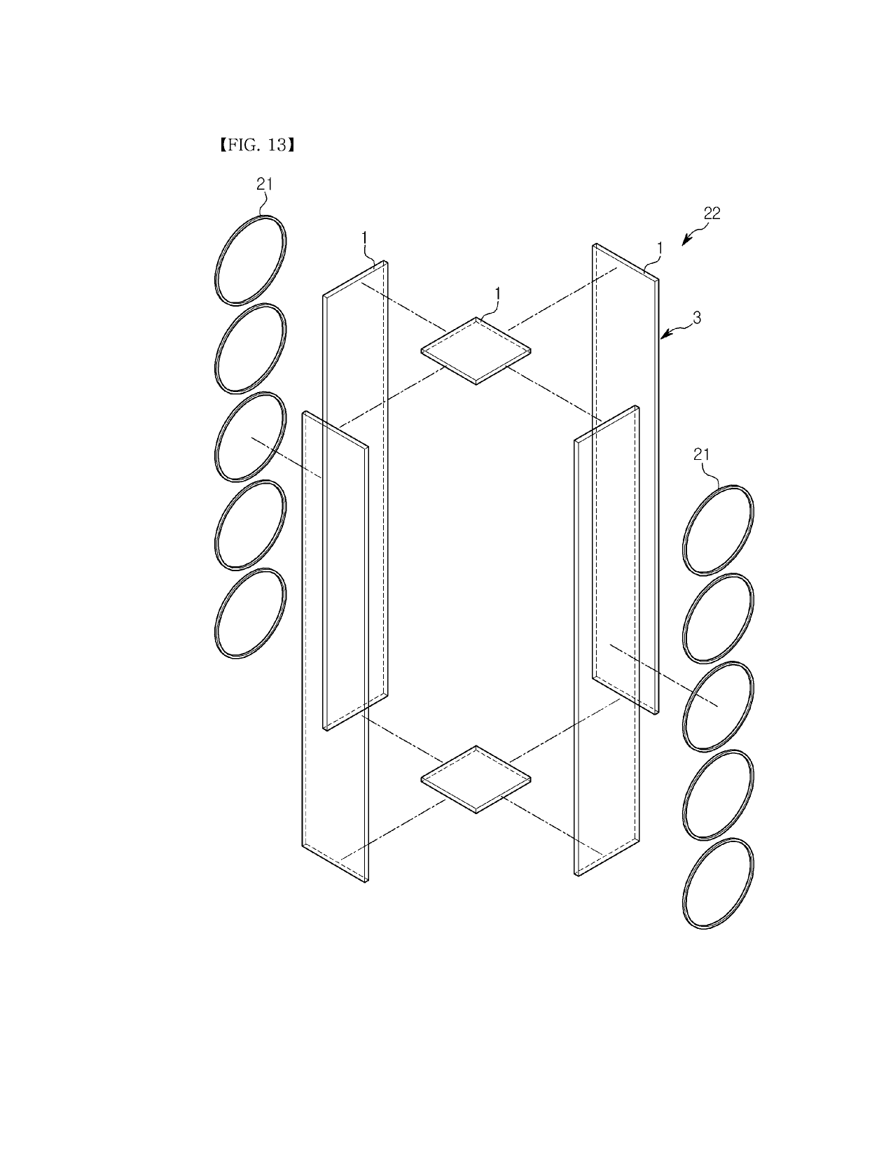

More specifically, as shown in FIG. 13, a teaching tool 22 according to a second embodiment includes a hexahedral body 3, which is formed of transparent plates 1, and a plurality of circular rings 21 attached to the inner or outer surfaces of the transparent plates 1 at a regular or irregular interval along the longitudinal direction of the hexahedral body 3 so that each pair of the circular rings 21 can face each other. The circular rings 21 may be configured to have a specified color so that the circular rings 21 can be easily recognized from the outside.

For the sake of easier understanding of the present invention, description will be made on an example in which the circular rings 21 are arranged on two opposing transparent plates 1 at a regular interval along the longitudinal direction of the transparent plates 1.

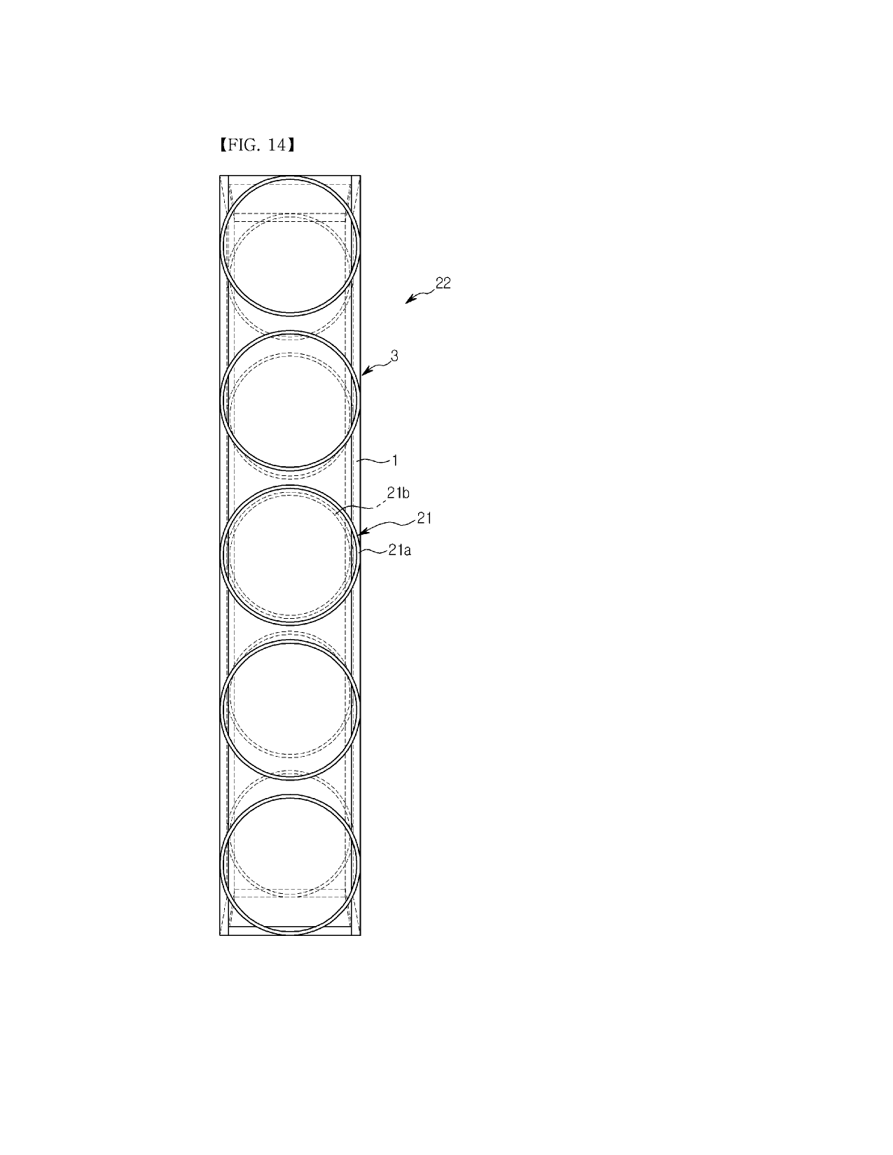

If the front and rear central circular rings 21a and 21b are observed from the front side of the teaching tool 22 as shown in FIG. 14, the rear central circular ring 20b looks as if it is located within the front central circular ring 20a. This is because the rear central circular ring 20b positioned farther away looks smaller.

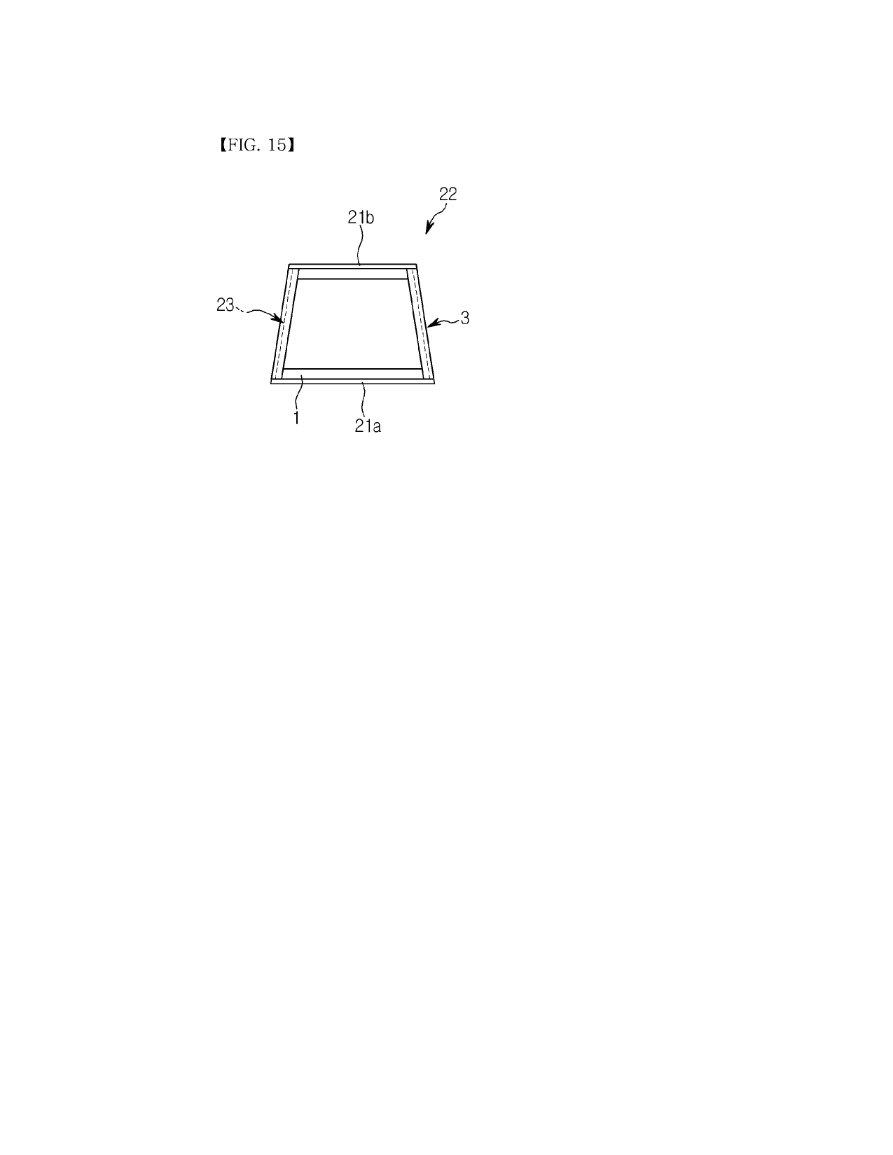

An imaginary circular column appears if the front circular ring 20a and the rear circular ring 20b are connected to each other. Since the rear circular ring 20b looks smaller, as shown in FIG. 15, the imaginary circular column 23 looks thinner as it extends rearward. It is therefore possible for a learner to visually recognize how the perfect circles look different depending on the viewing angles and how the visual shape of the imaginary circular column is changed depending on the viewing angles.

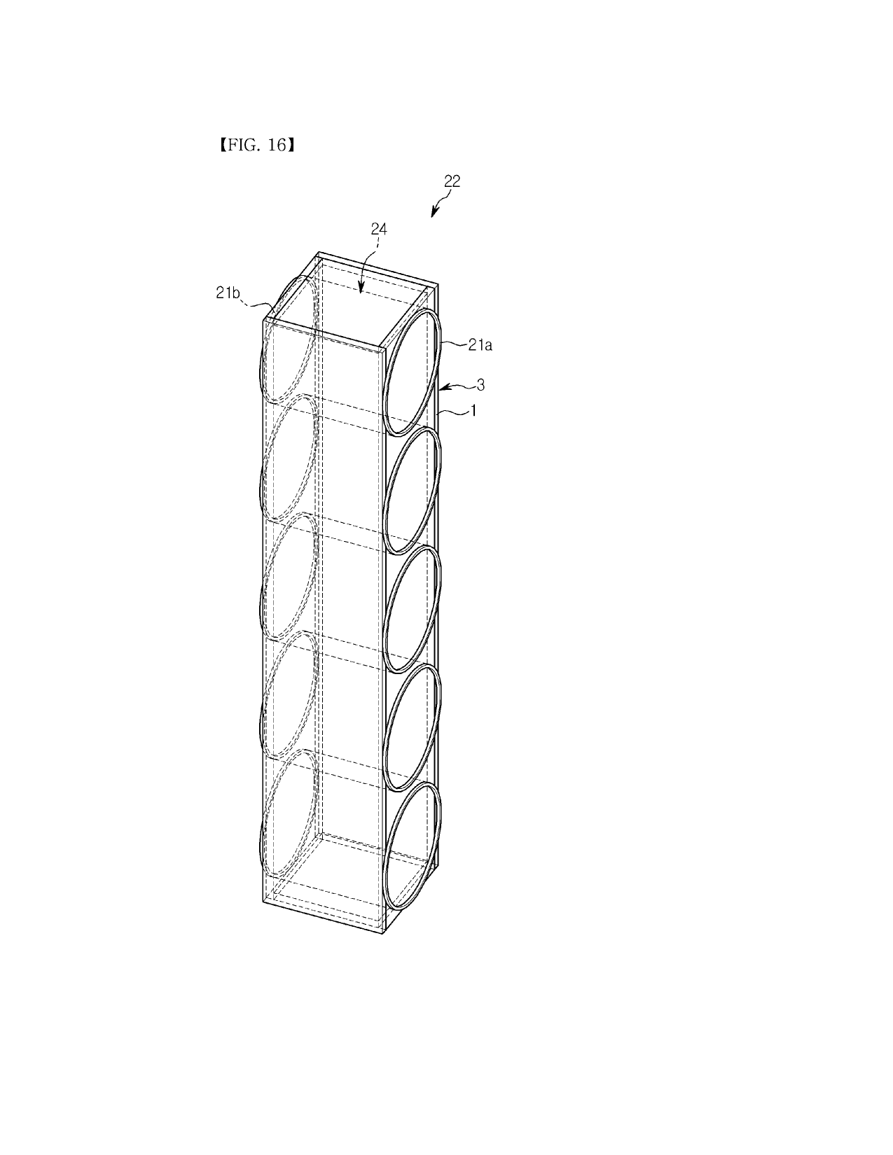

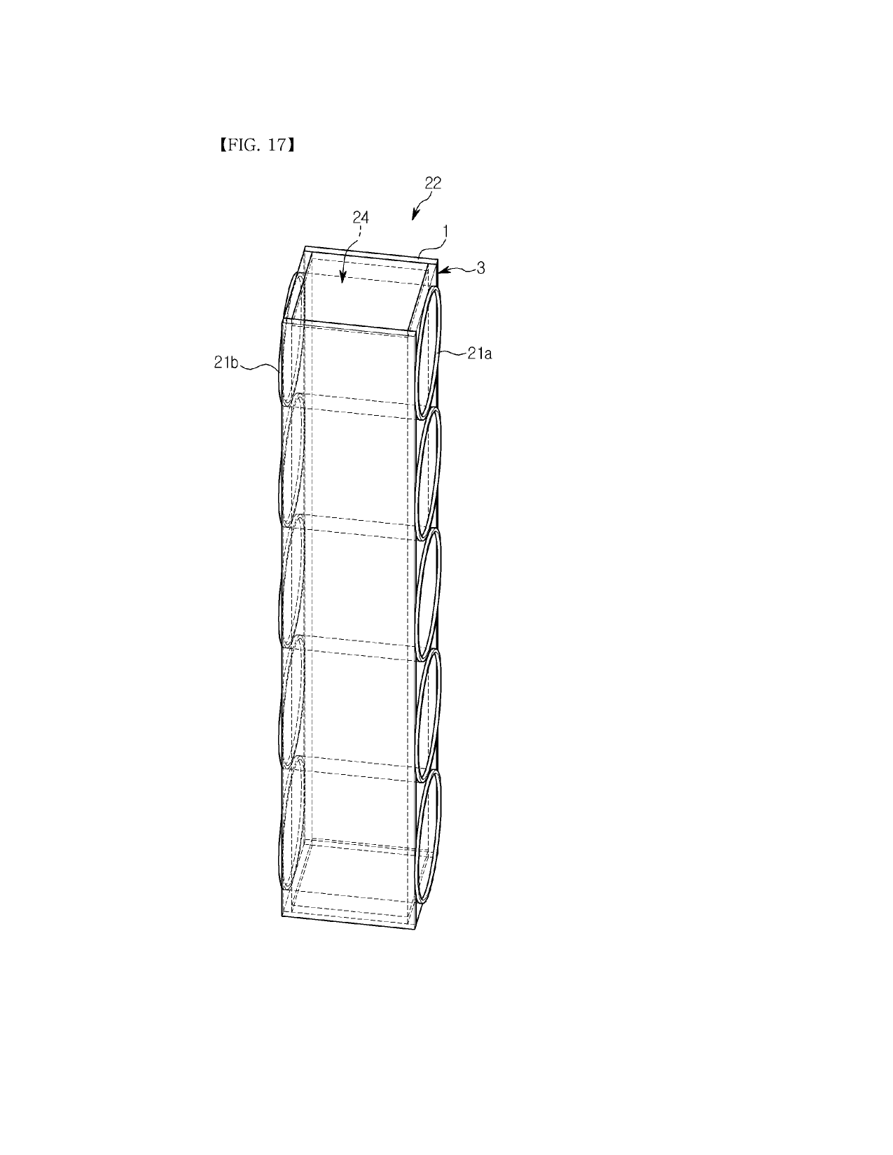

Referring to in FIG. 16, if the teaching tool 22 is observed from a position deviated from the front side, the circular rings 20a and 20b look elliptical. Turning to FIG. 17, if the viewing position is further moved to the lateral side, the circular rings 20a and 20b look like elliptical rings having a smaller width. The imaginary circular column 24 interconnecting the front and rear circular rings 20a and 20b looks like an elliptical column.

By enabling a learner to visually confirm how the circular rings look different depending on the viewing angles and how the visual shape of the circular column interconnecting two circular rings is changed depending on the viewing angles, it is possible to enhance the educational effect on the spatial geometry.

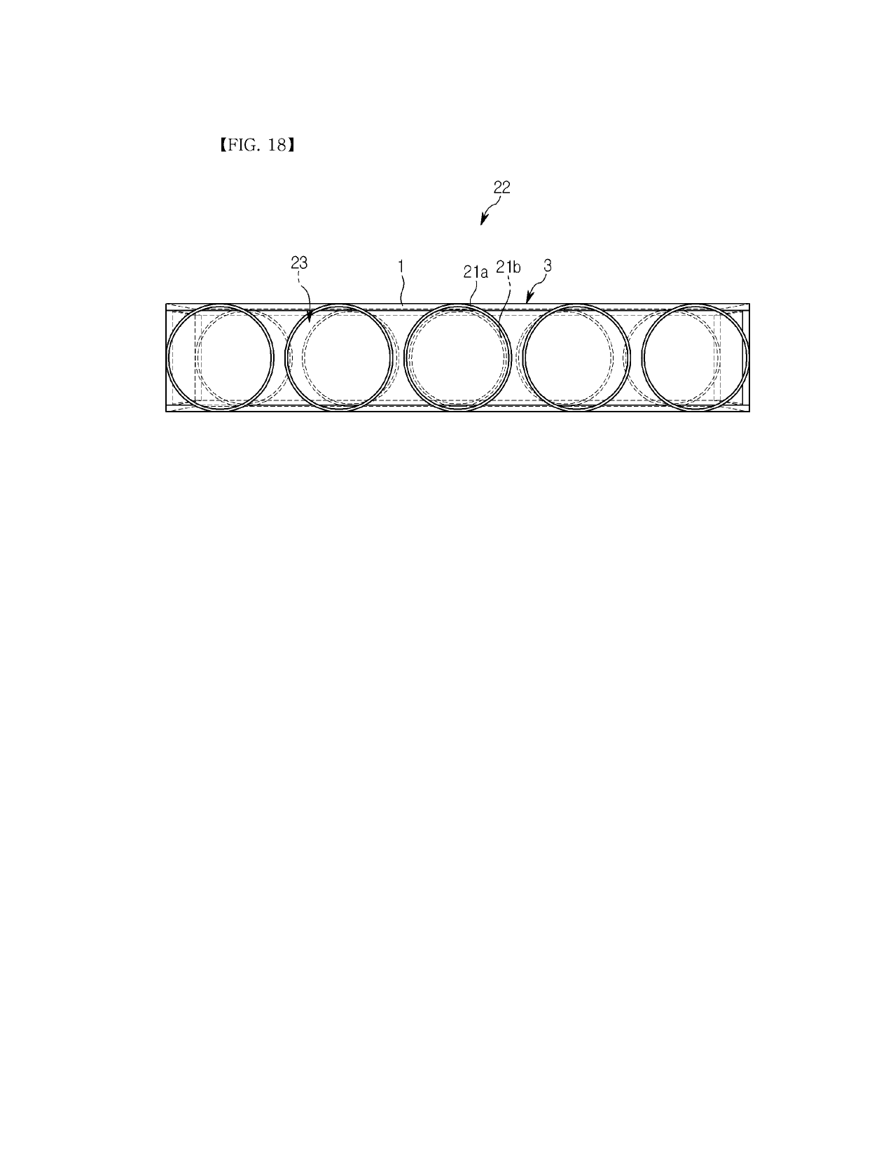

As shown in FIG. 18, the teaching tool 22 according to the second embodiment may be observed in a laying-down state and not in a standing state. In this case, if the front and rear central circular rings 21a and 21b are observed from the front side of the teaching tool 22, the rear central circular ring 20b looks as if it is located within the front central circular ring 20a. This is because the rear central circular ring 20b positioned farther away looks smaller.

An imaginary circular column appears if the front circular ring 20a and the rear circular ring 20b are connected to each other. Since the rear circular ring 20b looks smaller, as shown in FIG. 15, the imaginary circular column 23 looks thinner as it extends rearward.

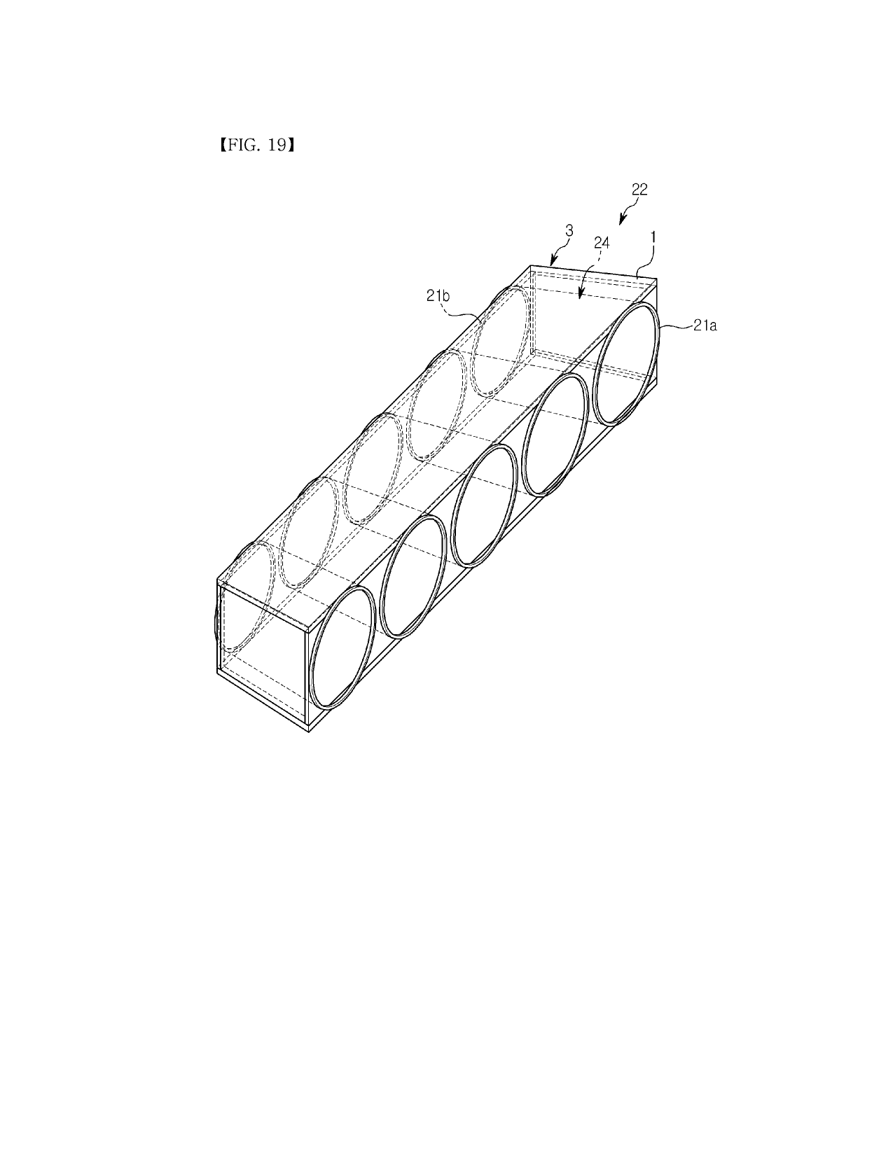

If the viewing position is moved to the left side or the right side (in the illustrated example, to the right side) as shown in FIG. 19, the front and rear circular rings 21a and 21b look elliptical. The rear circular rings 21b look smaller than the front circular rings 21a. Imaginary elliptical columns 24 appear if the front circular rings 21a and the rear circular rings 21b are connected to each other.

In this manner, the use of the teaching tool 22 according to the second embodiment of the present invention enables a learner to visually confirm how the circular rings look different depending on the viewing angles and how the visual shape of the circular column interconnecting two front and rear circular rings is changed depending on the viewing angles. This makes it is possible to enhance the educational effect on the spatial geometry.

In general, a hexahedron is three-dimensionally depicted by interconnecting corners thereof with straight lines. In this case, the visible front lines are indicated by solid lines but the hidden rear lines need to be indicated by dot lines. In order to accurately depict a hexahedron, it is necessary to understand the spatial geometry.

According to the present invention, there is provided a teaching tool that can enable a learner to accurately understand a hexahedron and to easily depict a hexahedron.

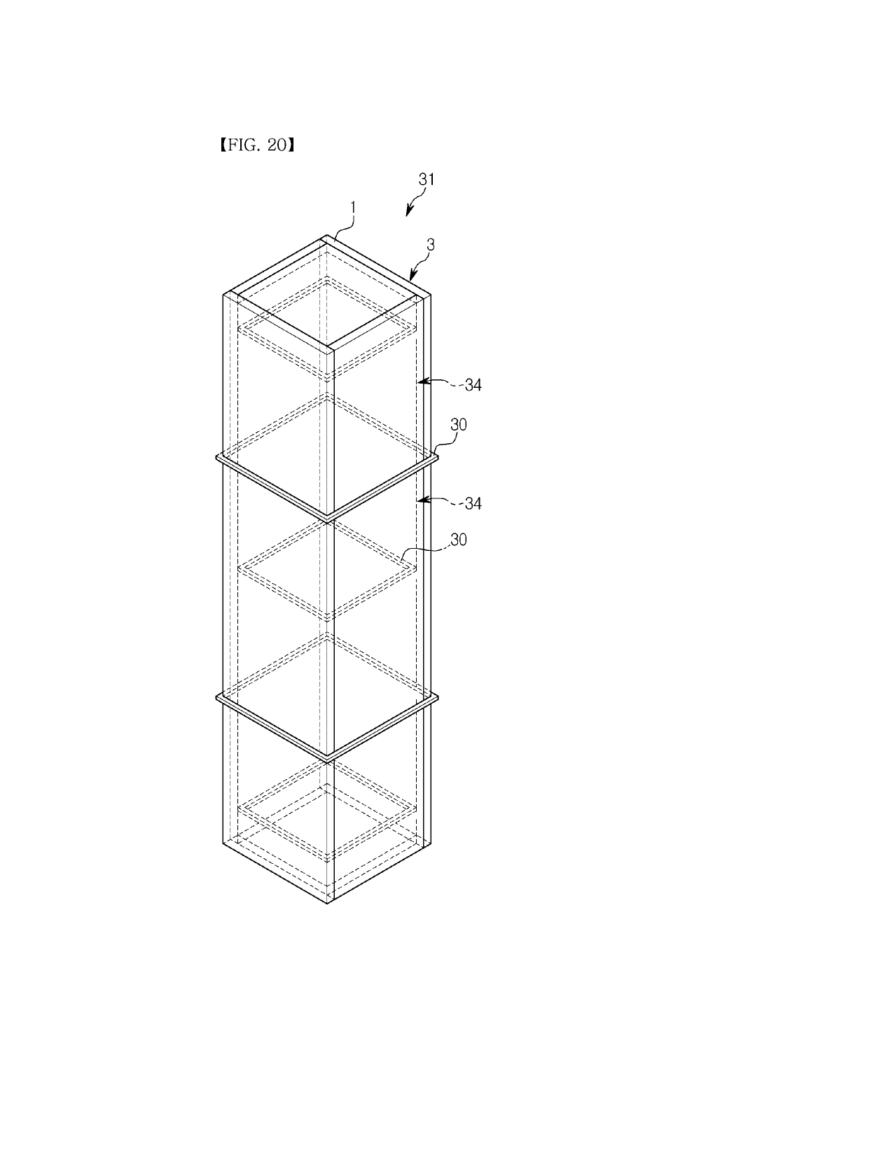

Referring to FIG. 20, a teaching tool 31 includes a transparent hexahedral body 3 and a plurality of horizontal bands 30 attached to the inner or outer surface of the hexahedral body 3. The hexahedral body 3 is divided into a plurality of hexahedral body parts 34 by the horizontal bands 30. The horizontal bands 30 may be configured to have a specified color so that the horizontal bands 30 can be readily observed from the outside.

With the teaching tool 31 of this configuration, the hexahedral body parts 34 are divided by the horizontal bands 30. The rear extensions of the horizontal bands 30 can be visually recognized through the transparent hexahedral body 3. This enables a learner to easily depict a hexahedron through the accurate understanding of spatial geometry of a hexahedron.

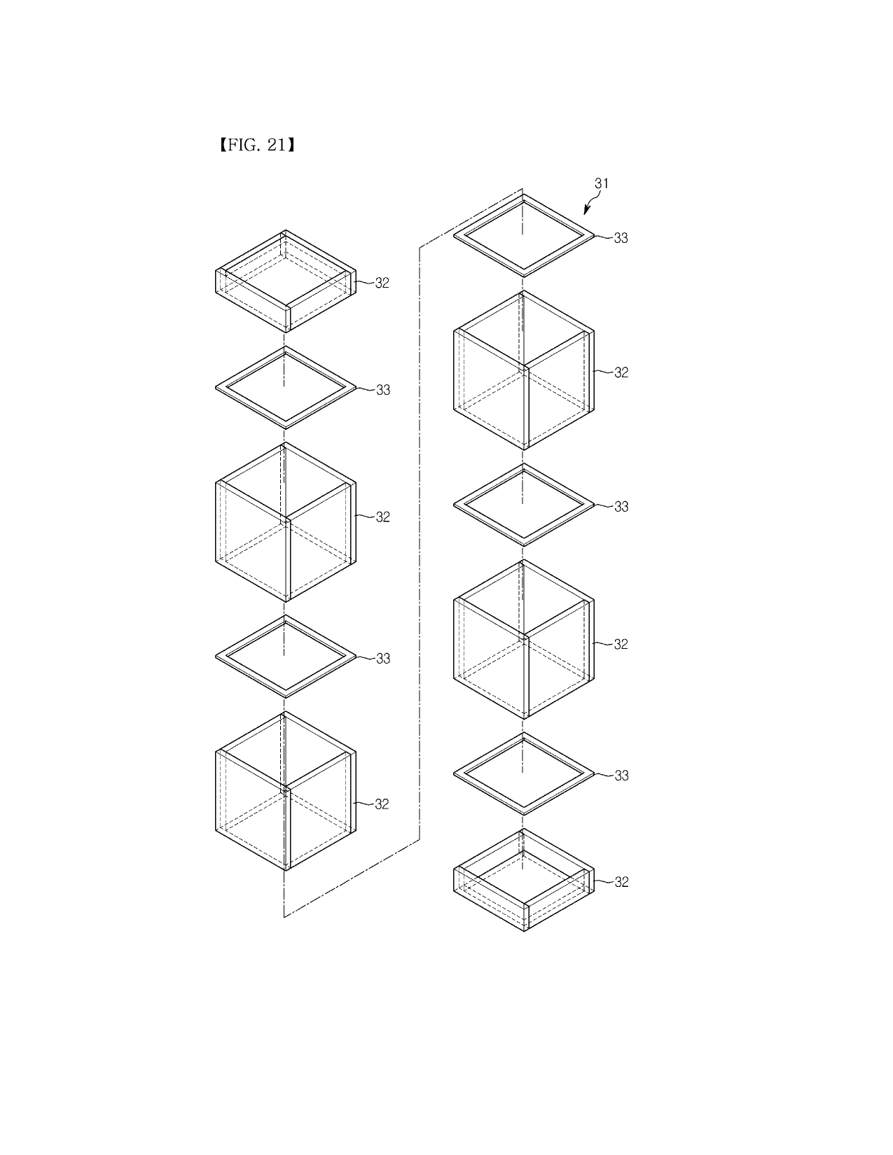

Alternatively, as shown in FIG. 21, the teaching tool 31 may be configured to include a plurality of transparent hexahedral bodies 32 and a plurality of opaque hexahedral bodies 33 having a width smaller than the width of the transparent hexahedral bodies 32. The transparent hexahedral bodies 32 and the opaque hexahedral bodies 33 are alternately arranged and are bonded to one another. The opaque hexahedral bodies 33 serve as the horizontal bands 30 shown in FIG. 20. Consequently, it is possible to provide the same effects as provided by the teaching tool 31 shown in FIG. 20.

With the teaching tools described above, it is possible to provide many different educational effects, including the increased understanding on how to depict a hexahedron on a planar surface and on the perspective of diagrams.

While certain preferred embodiments of the invention have been described above, the scope of the present invention is not limited to these embodiments. It will be apparent to those skilled in the art that various changes, modifications and substitutions may be made without departing from the scope of the invention defined in the claims. Such changes, modifications and substitutions shall be construed to fall within the scope of the present invention.

What is claimed is:

1. A teaching tool for easier understanding of a diagram looking different depending on viewing angles, comprising:
a transparent body (3) composed of transparent plates (1); and
a plurality of circular rings (2) arranged within the transparent body (3) at a specified interval.

2. The teaching tool as recited in claim 1, wherein each of the circular rings (2) is configured to have a specified color.

3. The teaching tool as recited in claim 1, wherein the transparent body (3) has a regular hexahedron shape or a rectangular parallelepiped shape.

4. The teaching tool as recited in claim 1, wherein the transparent body (3) is a hollow transparent cylindrical columnar body (11).

5. The teaching tool as recited in claim 1, wherein the circular rings (2) includes a large circular ring (2) and a small circular ring (99) smaller in diameter than the large circular ring.

6. The teaching tool as recited in claim 4, wherein the circular rings (2) includes a large circular ring (2) and a small circular ring (99) smaller in diameter than the large circular ring, the large circular ring (2) and the small circular ring (99) arranged within the hollow transparent cylindrical columnar body (11).

7. A teaching tool for easier understanding of a diagram looking different depending on viewing angles, comprising:
a hollow transparent cylindrical columnar body (11) having an outer circumferential surface; and
a plurality of circular bands (12) arranged on the outer circumferential surface of the hollow transparent cylindrical columnar body (11) at a specified interval.

8. The teaching tool as recited in claim 7, wherein the hollow transparent cylindrical columnar body (11) is a curved hollow transparent cylindrical columnar body (18).

9. A teaching tool for easier understanding of a diagram looking different depending on viewing angles, comprising:
a plurality of transparent cylindrical columnar members (14); and
a plurality of circular rings (13) interposed between the transparent cylindrical columnar members (14),
wherein the transparent cylindrical columnar members (14) and the circular rings (13) are alternately arranged and are bonded to one another.

10. The teaching tool as recited in claim 9, wherein each of the circular rings (13) is configured to have a specified color.

11. A teaching tool for easier understanding of a diagram looking different depending on viewing angles, comprising:
a transparent hexahedral body (3) composed of transparent plates (1); and
a plurality of circular rings (21) arranged on the transparent plates (1) in a mutually opposing relationship at a specified interval along a longitudinal direction of the transparent hexahedral body (3).

12. The teaching tool as recited in claim 11, wherein each of the circular rings (21) is configured to have a specified color.

13. A teaching tool for easier understanding of a diagram looking different depending on viewing angles, comprising:
a transparent hexahedral body (3) composed of transparent plates (1); and
a plurality of horizontal bands (30) arranged on the transparent hexahedral body (3) at a specified interval,
wherein the hexahedral body is divided into a plurality of hexahedral body parts (34) by the horizontal bands (30).

14. The teaching tool as recited in claim 13, wherein each of the horizontal bands (30) is configured to have a specified color.

15. A teaching tool for easier understanding of a diagram looking different depending on viewing angles, comprising:
a plurality of transparent hexahedral bodies (32); and
a plurality of opaque hexahedral bodies (33) smaller in width than the transparent hexahedral bodies (32),
wherein the transparent hexahedral bodies (32) and the opaque hexahedral bodies (33) are alternately arranged and are bonded to one another.

16. A teaching tool for easier understanding of a diagram looking different depending on viewing angles, comprising:
an outer transparent cylindrical columnar body (11);
a plurality of outer circular rings (2) arranged on an inner circumferential surface of the outer transparent cylindrical columnar body (11);
an inner transparent cylindrical columnar body (70) arranged at a center of the outer transparent cylindrical columnar body (11); and
a plurality of inner circular rings (72) arranged on the inner transparent cylindrical columnar body (70) in alignment with the outer circular rings (2).

17. The teaching tool as recited in claim 16, wherein the inner circular rings (72) are circular bands (71) attached to an outer circumferential surface of the inner transparent cylindrical columnar body (70).
